(19) United States
(12) Patent Application Publication
(10) Pub. No.: US 2010/0179937 A1
(43) Pub. Date: Jul. 15, 2010

(54) METHOD AND APPARATUS FOR BEHAVIORISTIC-FORMAT CODING OF QUALITATIVE ANALOG DATA/DISTRIBUTED AUTOMATION PROTOCOL

(76) Inventor: Michael Aberson, Haifa (IL)

Correspondence Address: EDWARD LANGER;c/o SHIBOLETH YISRAELI ROBERTS ZISMAN & CO., 1 PENN PLAZA-SUITE 2527, NEW YORK, NY, 10119, US

(21) Appl. No.: 12/352,619

(22) Filed: Jan. 13, 2009

(51) Int. Cl. G06N 7/02; G06F 17/30

(52) U.S. Cl. 706/52; 707/E17.044

(57) ABSTRACT

A control apparatus provided as a dedicated control unit which enables a standard software protocol in digital qualitative analog process data presentation, useful in line businesses and utilities, etc., which use SI basic and derived analog units such as temperature, voltage, current, pressure, speed, velocity, radiation, vibration, noise and other analog measurements units. The individual data controller operates based on a digital Discrete Economic Modulation (DEM) principle, which is a general method introduced for averaging within a special behavioristic control loop and provides coherent, flexible data for monitoring, on-line decision making and discrete optimization using classic procedures such as regression and the simplex method. The raw data input is converted in accordance with the DEM method, averaged four times a day, and stored in a buffer as a standard rectangular matrix digital format in which the 24-hour calendar day is divided into four 6-hour disjointed segments/half-periods, to provide four mean numbers per calendar day or one number a day for each 6-hour data file, as four time history files for coherent and flexible analysis without time lag and PC-oriented processing, as a standard protocol model for data highway networks.

### CROSS-REFERENCE TO RELATED PATENT

The present application is related to a previously issued patent by the same inventor, U.S. Pat. No. 5,732,193, issued Mar. 24, 1998, entitled METHOD AND APPARATUS FOR BEHAVIORISTIC-FORMAT CODING OF QUANTITATIVE RESOURCE DATA/DISTRIBUTED AUTOMATION PROTOCOL”, the disclosure of which is incorporated herein by reference.

### FIELD OF THE INVENTION

The present invention relates to information technology and management including instrumentation and data presentation methods and apparatus, and more specifically, to apparatus which provides time history files containing measured, stable, recurrent qualitative analog process data (e.g., temperature, voltage, pressure, speed, radiation, vibration, etc.), within predetermined periods, using a digital discrete economic modulation (DEM) principle, relating to a specific behavioristic control loop. This is the final work for my EWIT invention (“electronic wheel” information technology)—a full digital automatic system, completely operational without requiring a “human factor”. Bill Gates (founder of Microsoft) said: “normal computers can't deal with the numbers” (Time, 13 Feb. 2006, vol. 167, n. 7, p. 11). The present invention utilizes logical microprocessors which deal with the numbers. The present invention converts analog processes into numbers.

### BACKGROUND OF THE INVENTION

The basic functions of conventional up-to-date measured analog data process in metric practice (SI basic and derived units) usually are:

1) to sample and evaluate raw input values from sensors measuring process variables, and

2) to calculate current process conditions of a controlled device activity.

An example is the latest microprocessor-based transformer monitoring system, commercially available from Manometerfabric, Stockholm, Sweden, and sold under the trade name “Trafo Guard” (Bulletin TG1, 1991), which features advanced output and information printout format with true temperature points. Other examples are new multi-task signal analyzers/data loggers with high accuracy and great hardware possibilities, but traditional static output.

Even though there is a wide gap between up-to-date sophisticated instrumentation having high parametric accuracy, and out-of-date practices in metric analysis using static data presentation, metrology software is becoming an increasingly important tool of analysis.

Advanced steady-state data transducers (Telog, RIS, Metrosonics, etc.) provide the same raw data output, which must, however, be further processed on the PC. Up to now, stochastic information obtained by conventional or advanced data control apparatus has not provided any direct and coded data for making a controlled manufacturing process/product more efficient and productive using measured process variables for flexible analysis and decision making. This is a critical point. For instance, making a decision on improvements in a design or its performance usually requires an additional time-consuming, uncertain and expensive statistical process control/research involving the “human factor” (PC-oriented data processing). It is known-that for such research, a time history file of the process, with projection of averaging data on specific time intervals, is always required.

As mentioned above, the current approach to analog process data management/monitoring involves centralized data processing, with data presentation in various Formats, which are either too flexible or completely static.

The centralized data processing and static data presentation approaches place time-lag and operational limitations on the effectiveness of standard data management, using real-time object-oriented data processing and a general communication interface (protocol).

It would therefore be desirable to provide a qualitative analog process data acquisition and display system to maximize and communicate the economic usefulness of data processing and programming for fast and certain digital discrete optimization of the manufacturing process/product/service activity, using a compatible communication interface.

### SUMMARY OF THE INVENTION

Accordingly, it is a principal object of the present invention to overcome the above-mentioned conceptual disadvantages and to provide a control apparatus and method for:

1) a dedicated, individually measured analog signal presentation based on general standard software, using stochastic dynamics of the process, and

2) a general communication interface/protocol.

Thus, in accordance with a preferred embodiment of the present invention, a control apparatus is provided for acquisition/presentation of qualitative analog process data comprising:

timing means for defining a plurality of time intervals corresponding to portions of a fixed time period;

means for averaging the input of qualitative analog process raw data provided by a qualitative data process input means;

storage means for storing said averaged input qualitative analog process data in accordance with said defined time intervals, as time history files; and

means for displaying said stored averaged input qualitative analog process data in said time history files,

The inventive control apparatus can be provided as a dedicated/distributed control unit enabling a coherent, unified, integrated protocol in recurrent analog process data presentation for discrete optimization purposes. The inventive control apparatus operates within the standard tolerance ratings of the existing parametric range of the process data.

As a microprocessor-based controller, the apparatus utilizes conventional hardware blocks in combination with common control commands according to the ANSI/IEEE Std. 488-87 (time-schedule controller, two-level timer, A/D converter, buffer-storage, printing/record/ transmitting modules) which is used for the dedicated individual, but general, standard software digital code embodiment. The inventive apparatus operates according to a DEM (Discrete Economic Modulation) principle within the analog data acquisition subsystem where raw data are periodically sampled and crop-coded in a digital format through a conventional A/D converter via a two-level timer. The data is then distributed in disjoint buffer-storage cells via averaging and digital display means to present, for each cell, one number a day.

The control apparatus can be connected to all sensors or metering instruments in the stochastic process and provides totally distributed, group coding of standard raw data in non-fashion. The result is a new digital standard protocol model of DEM digital coded data.

The basic DEM principle introduced herein provides a special behavioristic control loop, by providing, within each calendar day, stochastic process decomposition and, accordingly, a disjoint, digital averaging means for converting original valid raw data via a standard sample, which is presented herein for any stable low-frequency recurrent (economic) stochastic process.

The profound difference of the DEM principle from classic control theory, wherein lies its novelty, is in its disregard for the noise problem within the behavioristic control loop. The DEM principle provides a full economic treatment of a recurrent stochastic low-frequency signal, by providing a significant mean (mathematical expectation) and non-significant random fluctuation (noise). This is the fundamental basis of the DEM principle, which distinguishes it from other well-known methods of analog signal modulation, including PCM (pulse code modulation).

The DEM principle digital parameters are:

1) 6: A standard 6-minute interval between each measurement of the original signal. This provides a sample takeoff probe. Using a standard digital parameter provides a recurrent low-frequency random process pulse—10 probes an hour;

2) 4×6: four 6-hour time history files per calendar day are presented in a digital-rectangular matrix, standard format. Thus, the DEM principle provides a behavioristic control loop for process signal analysis with a communication interface logic record.

The next standard digital parameter is provided by 6-hour averaging of data in a standard stochastic interval/half-period, providing 60 probes within every 6-hour time history file to convert every 60 probes into one number for presentation: four numbers per calendar day (e.g., for each 6-hour data file there are 7 numbers a week, . . . 365 numbers a year). An average 6-hour discrete decomposition (four process intervals) provides a time-independent/stationary approximation (close to Gaussian distribution) on every one of four intervals/half-periods.

With the DEM principle standard software approach, simple and correct processing/presentation of data is achieved, in accordance with the present invention; thus, a simple digital form of any recurrent analog process treatment in economic application is realized: four numbers per calendar day.

The four time history files may be represented by four colored areas, which correspond to the four numbers on each calendar day, can be printed as data output. The data output is ready for on-line local and strategic decision-making and for discrete optimization programming in a standard digital format/time history protocol.

Other features and advantages of the invention will become apparent from the following drawings and description.

### BRIEF DESCRIPTION OF THE DRAWINGS

For a better understanding of the invention with regard to the embodiments thereof, reference is made to the accompanying drawings, in which like numerals designate corresponding sections or elements throughout, and in which:

FIG. 1 illustrates a sampled analog signal in a data acquisition subsystem, useful as an example in describing a DEM (Discrete Economic Modulation) principle in accordance with the present invention;

FIG. 2 is a block-diagram of a preferred microprocessor-based embodiment of a control apparatus for processing variable analog parameters (such as temperature, voltage, pressure, speed, radiation, and vibration, etc.), constructed and operated in accordance with the principles of the present invention;

FIG. 3 is a rectangular matrix printout, in digital format, representing time history data files provided as the control apparatus output; and

FIG. 4 is a schematic illustration of a business unit information system cycle using the DEM principle for standard flexible analog output data provided by the control apparatus.

### DETAILED DESCRIPTION OF A PREFERRED EMBODIMENT

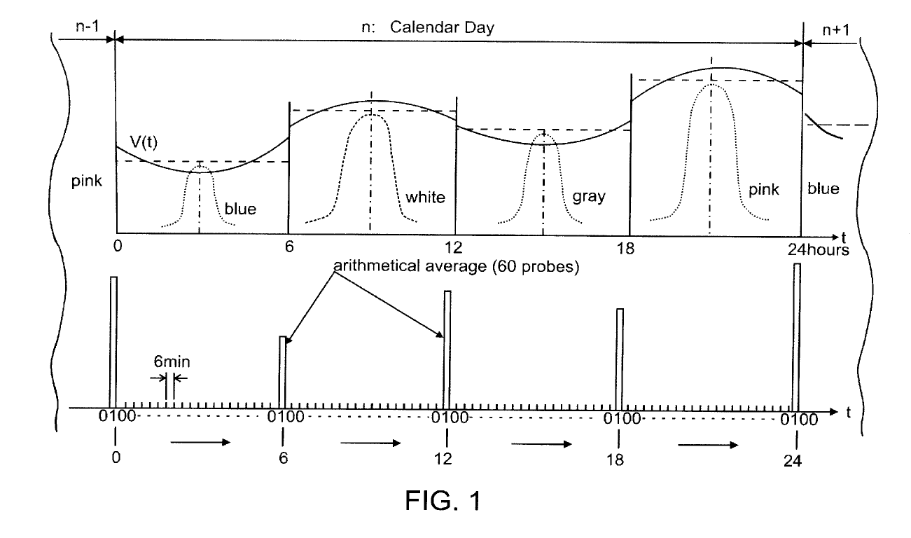

FIG. 1 shows a sampled formalized analog signal in a data acquisition subsystem, useful as an example in describing a DEM (Discrete Economic Modulation) principle in accordance with the present invention. The analog signal V(t) is representative of a process variable which is taken from a control loop cycle during a calendar day.

The DEM principle is based on:

1) discrete averaging of analog data to provide four mean values as an adequate numerical image for an essentially time-dependent stochastic process, a day/two-period behavioristic control loop cycle and its adequate presentation in disjoint fashion; that is, one mean/number for each 6-hour half-period/segment: see related patent (page 1).

2) an approximation, introduced here, which means that each 6-hour stochastic interval of the stable recurrent analog process is close to Gaussian distribution.

The signal V(t) is a typical formalized two-period curve within a standard tolerance range, which is associated with four discrete half-periods within the behavioristic control loop cycle for such an analog signal. Each half-period has one saddle point, that enables optimization of each half-period separately. This approach flows from the DEM principle (see FIG. 1).The classic control theory subject of process noise (up to spectral filtration, etc.), is not within the scope of the DEM principle, which is concerned with the mathematical expectation (mean) only.

In accordance with the present invention, the averaging process begins and ends four times a day with a 6-minute elementary “pulse” interval using 60 probes, which are converted and averaged as digital values (M), providing one number for every 6-hour stochastic interval: 00.01-06.00 (blue); 06.01-12.00 (white); 12.01-18.00 (gray); 18.01-24.00 (pink) within the behavioristic control loop cycle or four numbers, only, each calendar day.

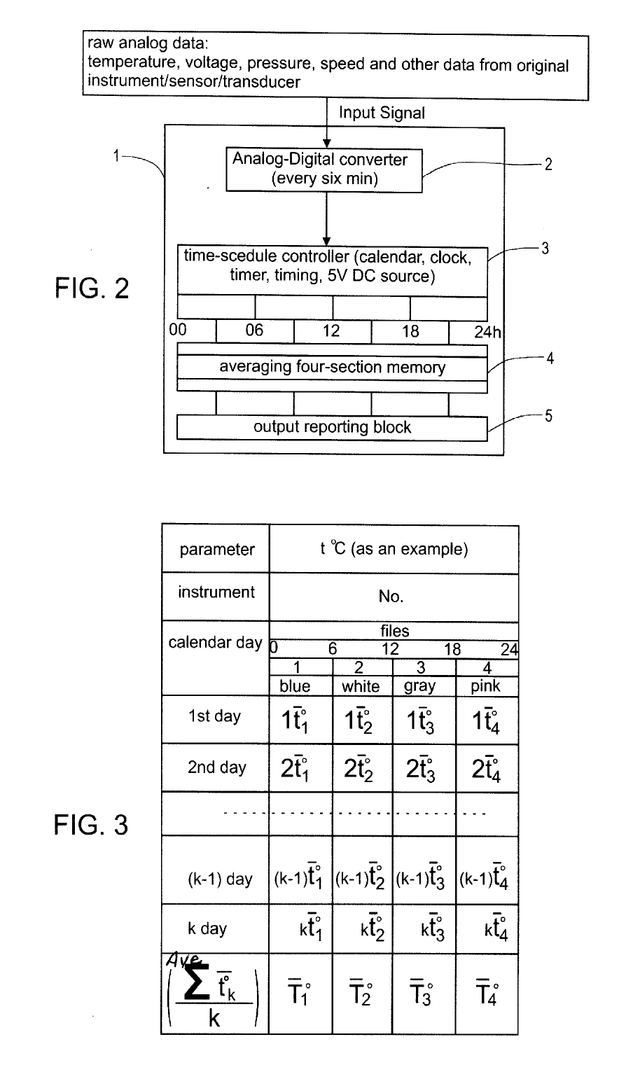

FIG. 2 is a block-diagram of a preferred embodiment of a control apparatus 1 for digital processing of variable analog parameters, constructed and operated in accordance with the principles of the present invention. Control apparatus 1 is functionally connected to a stationary or portable analog data sensor/measuring instrument, by means of electrical, electronic, optic, or any other short-distance transmission carrier which is capable of transferring data with acceptable accuracy (input signal distance). The raw analog data itself can be presented, for example, by International SI basic and derived units, such as temperature, electricity (V,A) pressure (atm, bar), speed (m/sec), rotational velocity (rev/sec), vibration (Hz), noise (dB), etc.

The raw analog data is fed to control apparatus 1, and is converted by an A/D converter 2 with a standard six-minute sample interval into digital signals (representing economic pulses in accordance with the DEM principle). The digital signals are then fed into a time-schedule controller 3, comprising a calendar, two-level timers for determining six-minute and six-hour time intervals, timing/synchronizing circuitry, and a 5 VDC independent power supply source.

The controller 3 distributes the raw digital data into the buffer storage block 4 for every 60 probes, which are averaged in a stochastic interval/half-period according to the DEM principle (by analog signal averaging and general behavioristic control loop cycle decomposition) as per FIG. 1. The rectangular matrix output data record during every predetermined 6-hour interval produces one of the four time history files as per FIG. 1:
00:01-06:00 (night/blue);
06:01-12:00 (morning/white);
12:01-18:00 (day/gray); and
18:01-24:00 (evening/pink)

The stored day-by-day digital data in the averaging four-section memory block 4 is four arithmetic mean/numbers a day, or one number a day in each time history file. These four time history files are ready for on-line decision making, or fast real-time object-oriented optimization programming procedures.

The time sequence of operation of control apparatus 1 is as follows. The raw analog input signal is fed to AID converter 2 every six minutes and then is distributed via time schedule controller 3, averaged every six hours a day, and stored in the buffer-storage averaging four-section memory block 4. In this way, four subdivided files are created wherein each number is an arithmetic mean of sixty measured (every six minutes) sequential raw analog signal probes in every day's 6-hour data file (rectangular matrix order format). The four time history files may be printed or marked in different paper colors to avoid identification error, e.g. blue, white, gray and pink.

Block 5 is an output reporting module that can be implemented as a printer/disk drive/communication transmitter unit in one output module.

Thus, the method and control apparatus are realized according to the DEM principle, as introduced here, using standard software for digital parameter processing.

FIG. 3 shows the data printout in rectangular matrix format representing (in colored digital display the four time history files as the result of the control apparatus 1 operation in accordance with the DEM principle. The format represents a 4-group coded digital data rectangular matrix, available in printed or record form, for local or strategic fast and certain decision-making in a stable, recurrent, economic analog process, for use with discrete, real-time object-oriented optimization programming procedures.

The proposed method and control apparatus is compatible with the main features of OSI layers (ISO), ASCII and ISDN: standardization, flexibility, compatibility, and integration, in order to provide access for a bi-directional data highway network.

As will be understood by those skilled in the art, the control apparatus may be modified by elimination of possible invalid input signals, if their random magnitudes are beyond a valid signal range, e.g., up to ±50%, instead of ±10%.

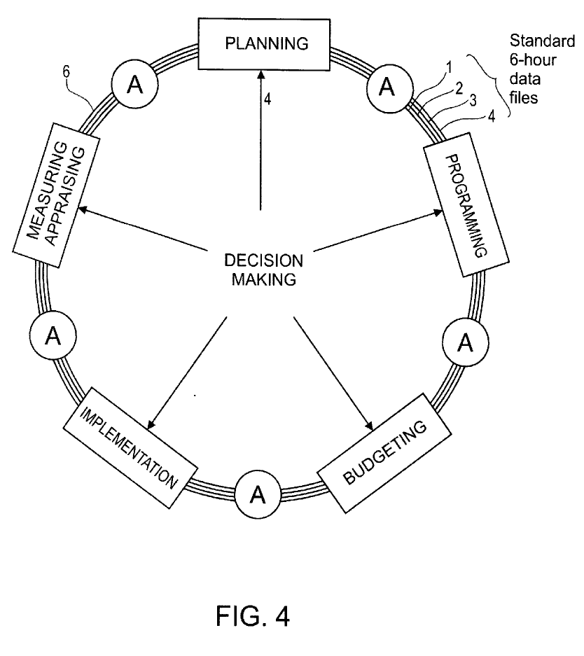

In FIG. 4, there is shown a schematic illustration of a business unit information system cycle using the DEM principle. The system uses standard flexible analog output data, as a standard protocol model containing four time history files as, provided by control apparatus 1. This approach may include the use of a data highway 6 on which qualitative analog data is transferable to various computer stations “A” for technological process analysis and decision-making.

Having described the invention with regard to certain specific embodiments thereof, it is to be understood that the description is not meant as a limitation, since further modifications may now become apparent to those skilled in the art, and it is intended to cover such modifications as fall within the appended claims.

I claim:

1. A control apparatus for acquisition/presentation, of qualitative analog process data comprising:
timing means for defining a plurality of time intervals corresponding to portions of a fixed time period;
means for averaging the input of qualitative analog process raw data provided by a qualitative analog process data input means;
storage means for storing said averaged input qualitative analog process data in accordance with said defined time intervals, as time history files; and
means for displaying said stored averaged input qualitative analog process data in said time history files.

2. The control apparatus of claim 1 wherein each of said time history files comprises a rectangular matrix containing four group coded values corresponding to four 6-hour daily periods.

3. The control apparatus of claim 1 wherein said qualitative analog process data input means comprises instrumentation providing data in digital form.

4. The control apparatus of claim 1 wherein said timing means, averaging means and storage means are implemented by a microprocessor-based qualitative analog process data input controller.

5. A method of acquisition/presentation of qualitative analog process data comprising the steps of:
defining a plurality of time intervals corresponding to portions of a fixed time period;
averaging the input of qualitative analog process raw data provided by a sensing means;
storing said averaged input qualitative analog process data in accordance with said plurality of time intervals, as time history files; and
displaying said stored averaged input qualitative analog process data in said time history files.

6. The method of claim 5 wherein said storing step is performed as a Discrete Economic Modulation (DEM) procedure to produce four time history files in accordance with four daily intervals each corresponding to a 6-hour period as follows:
00:01-06 00 (night),
06:01-12:00 (morning);
12:01-18:00 (day); and
18:01-24:00 (evening).

7. The method of claim 5 wherein said averaging step is performed in said DEM principle in accordance with a plurality of 6 minute sampling intervals between each measured and converted analog data, providing 10 sampling probes/pulses an hour, equivalent to 60 averaging probes per calendar day within each of said four 6-hour time history files.

8. The method of claim 5 wherein said displaying step includes printing said time history files as a rectangular matrix.

9. The method of claim 5 further comprising the step of transferring said time history files containing said qualitative analog data, said transferred four time history files being provided in a distributed automation protocol, over a data highway to a plurality of computing stations for performing, at least at one of said computing stations, at least one of the tasks of technological process analysis and decision-making.
